(19) United States
(12) Patent Application Publication
(10) Pub. No.: US 2023/0008751 A1
(43) Pub. Date: Jan. 12, 2023

(54) DYNAMIC GAIN ADJUSTMENT BASED ON DISTANCE TO TARGET IN AN ACTIVE LIGHT DETECTION SYSTEM

(71) Applicant: Seagate Technology LLC, Fremont, CA (US)

(72) Inventors: Walter R. Eppler, Cranberry Township, PA (US); Adam Robert Bush, Plymouth, MN (US)

(21) Appl. No.: 17/862,024

(22) Filed: Jul. 11, 2022

Related U.S. Application Data
(60) Provisional application No. 63/220,726, filed on Jul. 12, 2021.

(51) Int. Cl. G01S 17/931; G01S 17/10; G01S 7/4861; G01S 7/497; G01S 17/42; G01S 7/4865; G01S 7/486

(52) U.S. Cl. CPC G01S 17/931; G01S 17/10; G01S 7/4861; G01S 7/497; G01S 17/42; G01S 7/4865; G01S 7/4868

(57) ABSTRACT

Apparatus and method for adaptively adjusting amplifier gain based on detected distance to a target in a light detection and ranging (LiDAR) system. In some embodiments, the amplifier amplifies detected pulses obtained from a photodetector, and the gain is adjusted from among at least two selectable gain modes responsive to a measured time of flight (ToF) for the pulses. A first range of gain levels can be used for targets that are within a first maximum distance range, and a second range of gain levels can be used for targets that are beyond the first maximum distance range. Each mode can extend from a minimum to a maximum value along a selected linear slope. A gain adjustment circuit can use a Gilbert Cell or a multiplier and fully differential amplifier arrangement.

### RELATED APPLICATION

The present application makes a claim of domestic priority under 35 U.S.C. 119(e) to U.S. Provisional Patent Application No. 63/220,726 filed Jul. 12, 2021, the contents of which are hereby incorporated by reference.

### SUMMARY

Various embodiments of the present disclosure are generally directed to an apparatus and method for adaptively adjusting amplifier gain based on detected distance to a target in a light detection and ranging (LiDAR) system.

Without limitation, in some embodiments the amplifier amplifies detected pulses obtained from a photodetector, and a gain applied to the amplifier output is adjusted from among at least two selectable gain modes responsive to a measured time of flight (ToF) for the pulses. A first range of gain levels can be used for targets that are within a first maximum distance range, and a second range of gain levels can be used for targets that are beyond the first maximum distance range. Each mode can extend from a minimum to a maximum value along a selected linear slope. A gain adjustment circuit can use a Gilbert Cell or a multiplier and fully differential amplifier arrangement.

These and other features and advantages of various embodiments can be understood from a review of the following detailed description section in conjunction with a review of the accompanying drawings.

### BRIEF DESCRIPTION OF THE DRAWINGS

FIG. 1 is a block representation of a data handling system constructed and operated in accordance with various embodiments of the present disclosure.

FIG. 2 shows an emitter of the system in some embodiments.

FIGS. 3A and 3B show different types of output systems that can be used by various embodiments.

FIG. 4 shows a detector of the system in some embodiments.

FIG. 5 illustrates a generalized variable gain amplifier (VGA) circuit that can be incorporated into the circuitry of FIGS. 1 and 2 in some embodiments.

FIG. 6 is a graphical representation of different gain responses that can be achieved using the circuit of FIG. 5.

FIG. 7 shows another detector of the system in accordance with further embodiments.

FIG. 8 is a schematic representation of gain adjustment circuitry of FIG. 7 which utilizes a Gilbert Cell arrangement in some embodiments.

FIG. 9 is a schematic representation of gain adjustment circuitry of FIG. 7 which uses a multiplier circuit arrangement in other embodiments.

FIG. 10 is a sequence diagram for an adaptive gain adjustment operation of the system in some embodiments.

FIG. 11 depicts pulses that are emitted and detected by the system in some embodiments.

FIG. 12 shows further aspects of the system in some embodiments.

### DETAILED DESCRIPTION

Various embodiments of the present disclosure are generally directed to optimization of an active light detection system.

Light Detection and Ranging (LiDAR) systems are useful in a number of applications in which range information (e.g., distances, etc.) from an emitter to a target are detected by irradiating the target with electromagnetic radiation in the form of light. The range information is detected in relation to timing and/or waveform characteristics of reflected light received back by the system. LiDAR applications include autonomously piloted or driver assisted vehicle guidance systems, topographical mapping, surveying, and so on. LiDAR systems are particularly useful in generating a three-dimensional (3D) point cloud representation of the surrounding environment in the applicable field of view (FoV). While not limiting, the light wavelengths used in a typical LiDAR system may range from ultraviolet to near infrared (e.g., 250 nanometers, nm to 1500 nm or more) with native light frequencies in the terahertz (THz, 10¹² Hz) range. Other wavelength and frequency ranges can be used.

One commonly employed form of LiDAR is sometimes referred to as coherent pulsed LiDAR, which generally uses coherent light and detects the range based on detecting phase differences in the reflected light. Such systems may use a dual (IQ) channel detector with an I (in-phase) channel and a Q (quadrature) channel. Other forms of LiDAR systems can be used, however, including non-coherent light systems that may incorporate one or more detection channels.

While operable, these and other systems can encounter difficulties in detecting targets at relatively longer distances, due to the time of flight of the various emitted pulses being relatively large. Various embodiments of the present disclosure compensate for these and other effects by using time-based feedback to adaptively adjust a gain associated with the generation and emission of the emitted beam for various targets within the FoV.

In some embodiments, an adaptive gain adjustment circuit is used to control feedback to an amplifier stage, which may take the form of a TIA (transimpedance amplifier). This allows dynamic control of the gain of a TIA without introducing artifacts at the detector, which may take the form of an avalanche photodetector (APD) or other detector device. In some cases, a Gilbert Cell arrangement is used to provide the different gain ranges. In other cases, a multipler arrangement along with a fully differential amplifier arrangement is used.

Different ranges of gain can be provided for different target distances. The gain differential in each range can vary, with a ratio of around 100:1 being used in some cases. In at least some embodiments, the gain of the amplifier is nominally maintained in a linear range.

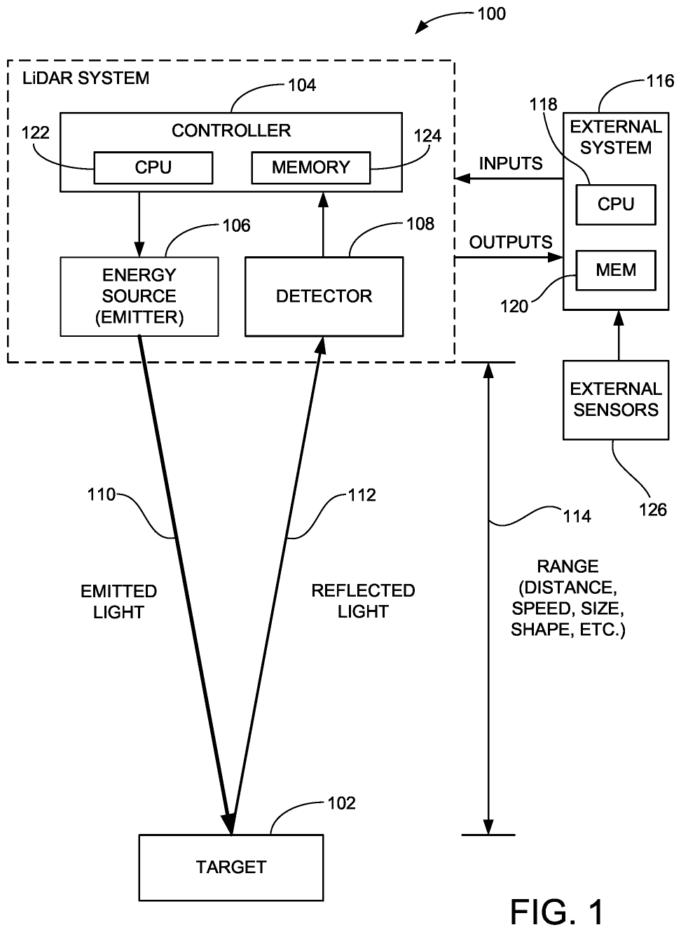

These and other features and advantages of various embodiments can be understood beginning with a review of FIG. 1, which provides a simplified functional representation of a LiDAR system 100 constructed and operated in accordance with various embodiments of the present disclosure. The LiDAR system 100 is configured to obtain range information regarding a target 102 that is located distal from the system 100. The information can be beneficial for a number of areas and applications including, but not limited to, topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 perform these operations directly, or can communicate the range information to an external system 116 for further processing and/or use.

In some cases, inputs supplied by the external system 116 can activate and configure the system to capture particular range information, which is then returned to the external system 116 by the controller 104. The external system can take any number of suitable forms, and may include a system controller (such as CPU 118), local memory 120, etc. The external system may form a portion of a closed-loop control system and the range information output by the LiDAR system 100 can be used by the external system 116 to adjust the position of a moveable element.

The controller 104 can incorporate one or more programmable processors (CPU) 122 that execute program instructions in the form of software/firmware stored in a local memory 124, and which communicate with the external controller 118. External sensors 126 can provide further inputs used by the external system 116 and/or the LiDAR system 100.

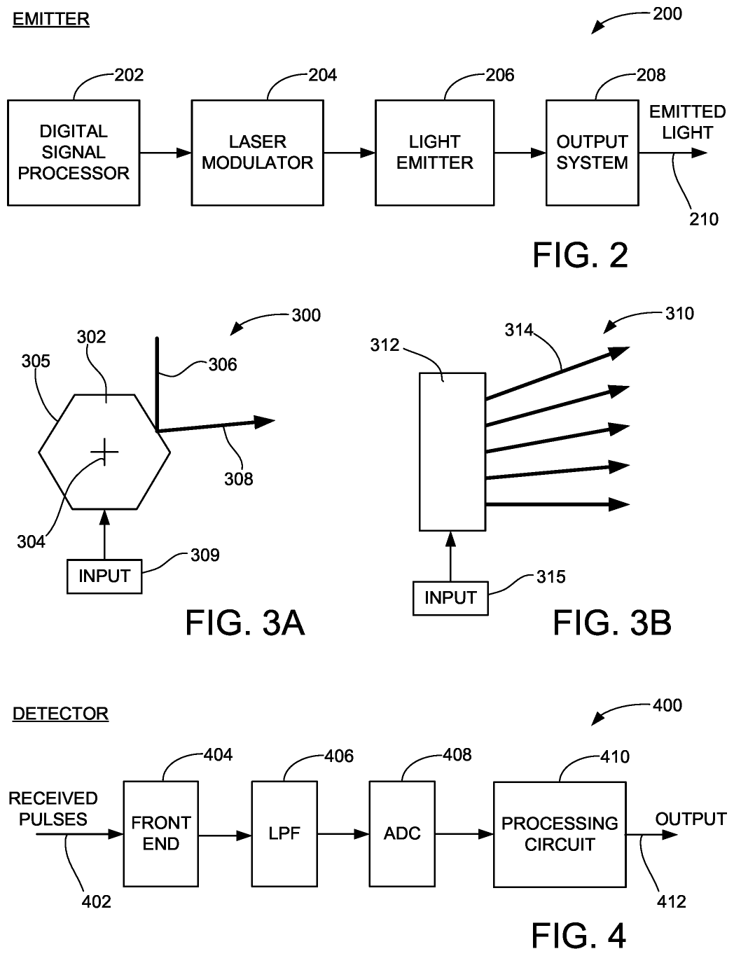

FIG. 2 depicts an emitter circuit 200 that can be incorporated into the system 100 of FIG. 1 in some embodiments. Other arrangements can be used so the configuration of FIG. 2 is merely illustrative and is not limiting. The emitter circuit 200 includes a digital signal processor (DSP) that provides adjusted inputs to a laser modulator 204, which in turn adjusts a light emitter (e.g., a laser, a laser diode, etc.)

that emits electromagnetic radiation (e.g. light) in a desired spectrum. The emitted light is processed by an output system 208 to issue a beam of emitted light 210. The light may be in the form of pulses, coherent light, non-coherent light, swept light, etc.

FIGS. 3A and 3B show different aspects of some forms of output systems that can be used by the system of FIG. 2. Other arrangements can be used. FIG. 3A shows a system 300 that includes a rotatable polygon 302 which is mechanically rotated about a central axis 304 at a desired rotational rate. The polygon 302 has reflective outer surfaces 305 adapted to direct incident light 306 as a reflected stream 308 at a selected angle responsive to the rotational orientation of the polygon 302. The polygon is characterized as a hexagon with six reflective sides, but any number of different configurations can be used. By coordinating the impingement of light 306 and rotational angle of the polygon 302, the output light 308 can be swept across a desired field of view (FoV). An input system 309, such as a closed loop servo system, can control the rotation of the polygon 302.

FIG. 3B provides a system 310 with a solid state array (integrated circuit device) 312 configured to emit light beams 314 at various selected angles across a desired FoV. Unlike the mechanical system of FIG. 3A, the solid state system of FIG. 3B has essentially no moving parts. As before, a closed loop input system 315 can be used to control the scan rate, density, etc. of the output light 314. Other arrangements can be used as desired, including DLP (micromirror) technology, etc.

Regardless the configuration of the output system, FIG. 4 provides a generalized representation of a detector circuit 400 configured to process reflected light issued by the system of FIG. 2. The detector circuit 400 receives reflected pulses 402 which are processed by a suitable front end 404. The front end 404 can include optics, detector grids, amplifiers, mixers, and other suitable features to present input pulses reflected from the target. The particular configuration of the front end 404 is not germane to the present discussion, and so further details have not been included. It will be appreciated that multiple input detection channels can be utilized.

A low pass filter (LPF) 406 and an analog to digital converter (ADC) 408 can be used as desired to provide processing of the input pulses. A processing circuit 410 provides suitable signal processing operations to generate a useful output 412.

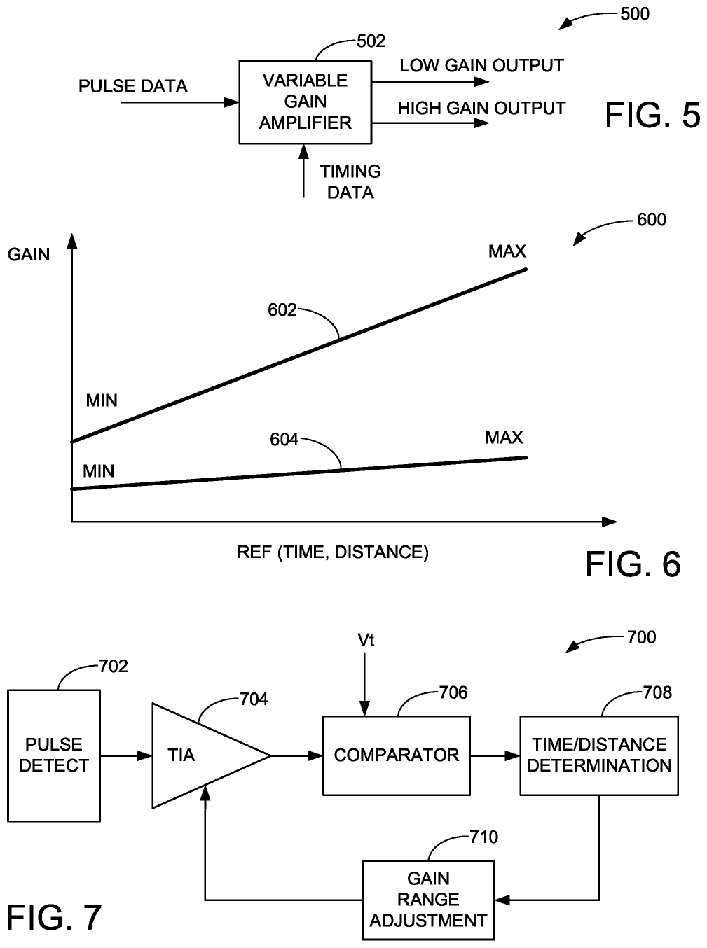

FIG. 5 generally represents a processing circuit 500 that can be incorporated into the system 100 of FIG. 1. A variable gain amplifier (VGA) circuit 502 operates in different selectable modes responsive to various inputs such as pulse data and timing data to provide a low gain output and a high gain output. While only two such outputs are shown, it will be understood that more than two modes can be generated as desired (including one or more intermediate modes as desired).

FIG. 6 is a graphical representation 600 of different responses provided by the circuit 502 of FIG. 5. A first response 602 represents operation using the high gain output and a second response 604 represents operation using the low gain output. Both show min and max values in relation to a reference x-axis (e.g., elapsed time, distance to target, etc.).

The response 602 may be applied to longer distance targets and the response 604 may be applied to closer targets. In other embodiments, the differential among targets within a given FoV may be evaluated and a suitable gain range (e.g., 602, 604) may be selected that optimally accounts for the various targets with appropriate weighting. In still other embodiments, different gains may be instantaneously supplied for different targets within the same FoV based on their different detected distances.

This arrangement allows the use of an adaptive gain adjustment circuit that adjusts a gain of an amplifier used to detect pulses reflected from a target to provide at least two selectable gain modes, each of the gain modes associated with a different measured time of flight of a light beam emitted by the system to the target. A range detection circuit can be used to determine a distance between the LiDAR system and the target, and the adaptive gain adjustment circuit can operate to change the gain of the amplifier from a first range of gain levels to a different second range of gain levels responsive to the determined distance (e.g., switch between profile 602 and 604, etc.). In some cases, the first range of gain levels can be used for targets that are within a first maximum distance range, and the second range of gain levels can be used for targets that are beyond the first maximum distance range.

FIG. 7 shows a detection system 700 constructed and operated in accordance with further embodiments. The system 700 can be incorporated into the various systems described above including the LiDAR system 100 of FIG. 1. It will be appreciated that the system 700 is merely illustrative and is not limiting, as other circuit arrangements can be used in accordance with the principles set forth in the present disclosure.

A pulse detect stage 702 receives reflected pulses from a selected target. As described above, this can include optics, APDs, and other front-end processing elements. The output is supplied to a TIA 704 which converts the input current pulse to a voltage pulse of selected magnitude. The TIA 704 may further act as an electronic filter, such a low-pass filter that removes or attenuates high-frequency electrical noise by attenuating signals above a particular frequency.

The TIA 704 may be provided with its own internal adjustable gain stage, or a separate downstream gain stage (not shown) can be provided to amplify the output voltage signal to a selected range as set forth above in FIGS. 5-6. Regardless, the output of the TIA is subjected to a selected gain range to generate an output that is processed by a downstream comparator circuit 706. The comparator circuit 706 produces an electrical-edge signal (e.g., a rising edge or a falling edge) when the received voltage signal rises above Of falls below a predetermined threshold voltage Vₜ.

A time/distance determination circuit 708 receives the edge detection signals from the comparator 706 and determines range information therefrom, including an interval of time between emission of a pulse of light by the light source of the emitter (see FIG. 2) and receipt of the edge signal from the comparator 706, referred to as the time of flight (ToF). The output of the circuit 708 may be a numerical value that corresponds to the TOF, and may be a relatively short value such as in the nano to pico range (e.g., 10⁻¹² to 10⁻¹⁵ seconds). A high speed internal clock may be used to digitize the ToF to some selected gradient.

The ToF flight information is used to generate an accurate determination of the actual distance between the emitter and the target. This information is supplied to a gain adjustment circuit 710, which in turn adjusts a gain utilized of the TIA 704. Longer distance targets will tend to provide lower power reflected signals and hence, may be processed using a higher (greater slope) gain range (e.g., 602), while shorter distance targets will provide higher power reflected signals and hence may be processed using a lower (flatter slope) gain range (e.g., 604). It can be seen that the various gain ranges supplied by the gain range adjustment circuit 710 can be both over absolute gain range values as well as differences between the minimum and maximum values within the range. This provides the system with the capability of providing an optimum resolution of the point cloud data based on the actual range to the target.

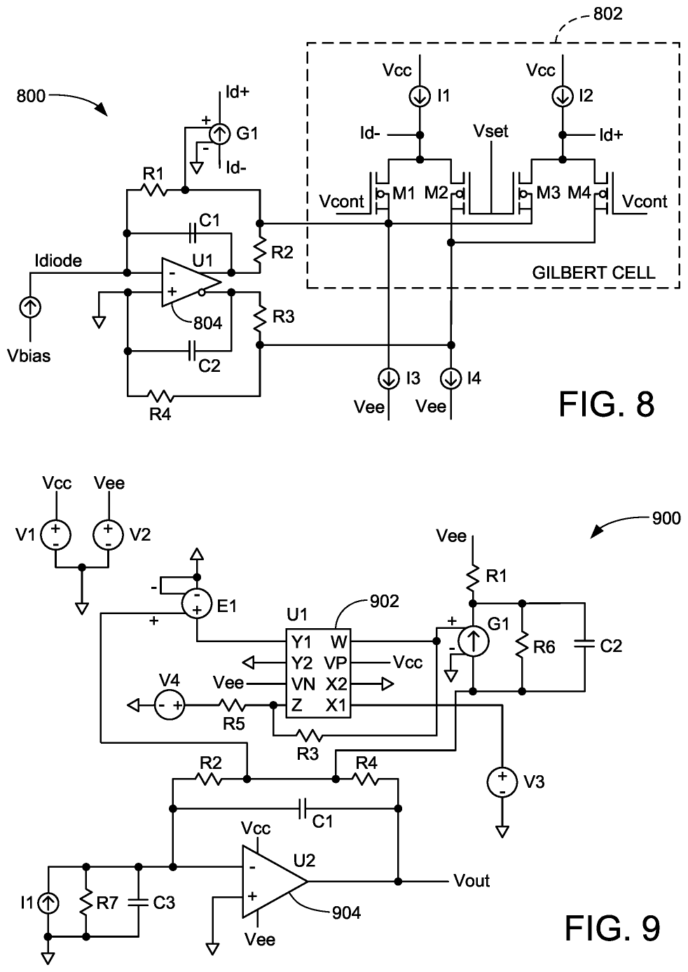

FIGS. 8 and 9 show respective schematic diagrams 800, 900 that can be incorporated into the circuitry of FIGS. 1, 4, 5 and 7 in various embodiments to carry out the adaptive gain adjustments disclosed herein. Other arrangements can be used.

FIG. 8 uses a Gilbert Cell circuit 802 comprising multiple p-channel MOS devices M1-M4 to selectively adjust the feedback gain of an amplifier 804 (U1) in response to voltage control inputs Vcont. The U1 amplifier 804 can correspond to the TIA 704 or can be a downstream gain stage that amplifies the output of the TIA by the gain established by the Gilbert Cell 802. Without limitation, the U1 amplifier 804 can be an Analog Devices LTC6363 differential amplifier.

FIG. 9 shows an alternative construction in which a multiplier device 902 (U1) adjusts the gain of amplifier 904 (U2) based on various input values X, Y and Z. As before, the U2 amplifier 904 can serve as the TIA or can be a downstream amplifier stage. Without limitation, the U1 multiplier 902 can be an Analog Devices AD835 device and the U2 amplifier 904 can be an Analog Devices LTC6269-10 operational amplifier.

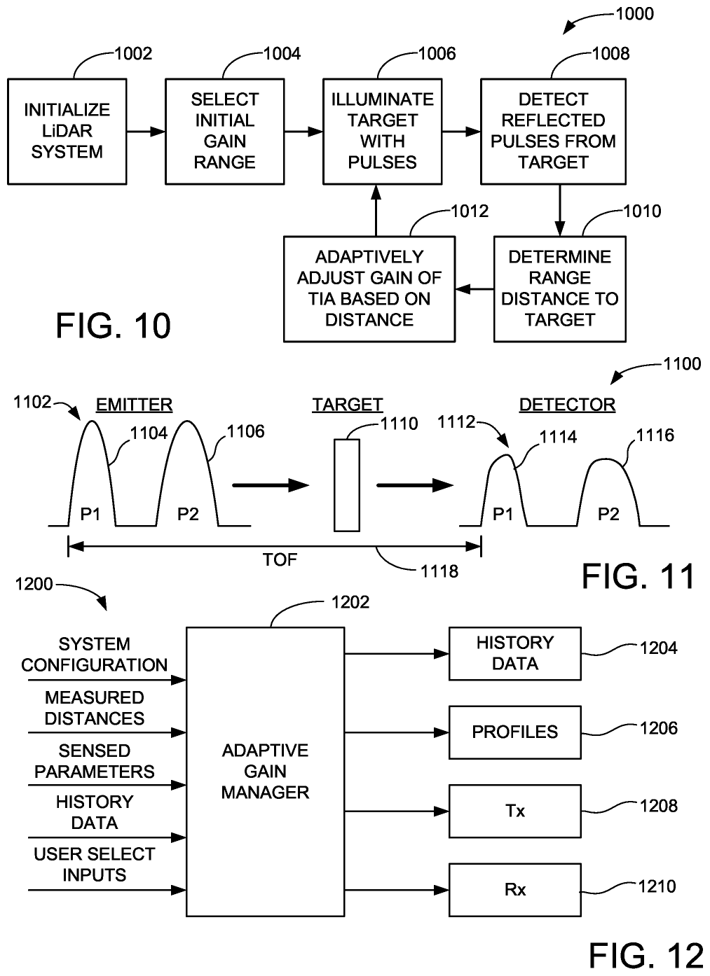

FIG. 10 is a sequence diagram 1000 to show operations carried out in accordance with various embodiments. The diagram 1000 is merely illustrative and is not limiting, as other steps can be carried out depending on the configuration of a given application.

A LiDAR system such as 100 in FIG. 1 is initialized at block 1002. An initial gain range is selected and implemented at 1004. This initial gain range can be based on a default setting or can be based on previously received range data.

Light pulses are transmitted at block 1006 to illuminate various targets within the FoV as described above including the emitter 200 of FIG. 2 and the output systems of FIGS. 3A-3B. Reflected pulses from a particular target are detected at block 1008 using a detector system as provided including at FIGS. 4, 5 and 7. A range to the particular target is determined at block 1010, and this detected range is used at block 1012 to adaptively adjust, as required, the gain associated with the output of the TIA based on the detected distance.

As described previously, different gain ranges can be selected and used for different targets within the same FoV. Closer targets within the point cloud can be provided with one range with a lower slope and magnitude values to obtain optimal resolution of the closer targets, while at the same time farther targets within the point cloud can be provided with one or more different gain ranges with higher slopes and/or different magnitude values to obtain optimal resolution of the farther targets.

FIG. 11 shows a simplified graphical flow diagram of a pulse transmission and reflection sequence 1100 carried out in accordance with various embodiments. An initial set of pulses is depicted at 1102 having two pulses 1104, 1106 denoted as P1 and P2. Each pulse may be provided with a different associated frequency or have other characteristics to enable differentiation by the system. The emitted pulses 1104, 1106 are quanta of electromagnetic energy that are transmitted downrange toward a target 1110.

Reflected from the target is a received set of pulses 1112 including pulses 1114 (pulse P1) and 1116 (pulse P2). The time of flight (TOF) value for pulse P1 is denoted at 1118. Similar TOF values are provided for each pulse in turn.

The received P1 pulse 1114 will likely undergo frequency doppler shifting and other distortions as compared to the emitted P1 pulse 1104. The same is generally true for each successive sets of transmitted and received pulses such as the P2 pulses 1106, 1116. Nevertheless, the frequencies, phase and amplitudes of the received pulses 1114, 1116 will be processed as described above to enable the detector circuit to correctly match the respective pulses and obtain accurate distance and other range information.

FIG. 12 shows an adaptive gain management system 1200 that can be incorporated into the system 100 of FIG. 1 in some embodiments. The system 1200 includes an adaptive gain manager circuit 1202 which operates to implement distance-based gain adjustments to the decoder as described above. The manager circuit 1202 can be incorporated into the controller 104 such as a firmware routine stored in the local memory 124 and executed by the controller processor 122.

The manager circuit 1202 uses a number of inputs including system configuration information, measured distance for various targets, various other sensed parameters from the system (including external sensors 126), history data accumulated during prior operation, and user selectable inputs. Other inputs can be used as desired.

The manager circuit 1202 uses these and other inputs to provide various outputs including accumulated history data 1204 and various profiles 1206, both of which can be stored in local memory such as 124 for future reference. The history data 1204 can be arranged as a data structure providing relevant history and system configuration information. The profiles 1206 can describe different pulse set configurations with different numbers of pulses at various frequencies and other configuration settings, as well as other appropriate gain levels, ranges and slopes for different sizes, types, distances and velocities of detected targets.

The manager circuit 1202 further operates to direct various control information to an emitter (transmitter Tx) 1208 and a detector (receiver Rx) 1210 to implement these respective profiles. It will be understood that the Tx and Rx 1208, 1210 correspond to the various emitters and detectors described above.

From the foregoing description it can be seen that the adaptive gain adjustments can be implemented in a number of ways, such as through the use of a fully differential amplifier and a Gilbert cell, or a multiplier and operational amplifier combination. Other circuit configurations can be used. While not necessarily required, the circuits advantageously maintain the transimpedance amp (TIA) in nominally a linear range. The differences in gain between min and max can be any suitable ratio, including up to or exceeding 100:1. In this way, one gain profile can be used for closer targets (e.g., lower time of flight) and the other gain profile can be used for farther targets (e.g., higher time of flight). Additional profiles can be selected based on substantially any desired operational parameters.

While coherent, I/Q based systems have been contemplated as a basic environment in which various embodiments can be practiced, such are not necessarily required. Rather, any number of different types of systems can be employed, including solid state, mechanical, etc.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An apparatus comprising an adaptive gain adjustment circuit in a light detection and ranging (LiDAR) system that selectively adjusts a gain of an amplifier used to detect pulses reflected from a target to provide at least two selectable gain modes responsive to a measured time of flight (ToF) of a light beam emitted by the LiDAR system to the target.

2. The apparatus of claim 1, further comprising a range detection circuit that determines a distance between the LiDAR system and the target, wherein the adaptive gain adjustment circuit changes the gain of the amplifier from a first range of gain levels to a different second range of gain levels responsive to the determined distance.

3. The apparatus of claim 2, wherein the first range of gain levels is used for targets that are within a first maximum distance range, and wherein the second range of gain levels is used for targets that are beyond the first maximum distance range.

4. The apparatus of claim 1, wherein each of the selectable gain modes extends from a minimum to a maximum value along a selected linear slope, wherein a first gain mode has a first set of minimum, maximum and slope values, and wherein a second gain mode has a different set of minimum, maximum and slope values.

5. The apparatus of claim 1, wherein the amplifier is characterized as a transimpedance amplifier (TIA) that converts pulses obtained from a photodetector to voltage pulses, and wherein the gain adjustment circuit adjusts a gain applied to said voltage pulses.

6. The apparatus of claim 1, wherein multiple pulses are emitted against the target and the ToF is determined as the time for a selected pulse from the multiple pulses to travel to the target, and the time for a reflected pulse from the target associated with the selected pulse to travel from the target to a photodetector.

7. The apparatus of claim 1, wherein the adaptive gain adjustment circuit applies a first gain mode to a first target within a field of view (FoV) of the system at a first detected distance from the system and concurrently applies a different, second gain mode to a second target within the FoV at a second detected distance greater than the first detected distance.

8. The apparatus of claim 1, wherein the gain adjustment circuit uses a Gilbert Cell arrangement comprising a plurality of transistors to adjust the gain of the amplifier.

9. The apparatus of claim 1, wherein the gain adjustment circuit uses a multiplier integrated circuit device and a differential amplifier to adjust the gain of the amplifier.

10. The apparatus of claim 1, wherein a low gain output is used for targets within a first determined distance from the system and a high gain output is used for targets beyond the first determined distance from the system.

11. The apparatus of claim 1, wherein the gain adjustment circuit generates and stores in a memory a plurality of profiles as data structures for different distances of targets, and wherein the gain adjustment circuit retrieves and uses a selected profile from the plurality of profiles responsive to a detected distance between the target and the LiDAR system based on a previously emitted pulse.

12. The apparatus of claim 1, wherein the gain adjustment circuit selects and uses a first gain mode to initiate operation of the system and transitions from the first gain mode to a different, second gain mode responsive to a determination of an intervening distance between the target and the system.

13. A method comprising:
selecting an initial gain to be applied to an amplifier that amplifies detected light pulses reflected from a target illuminated by an emitter;
determining a range distance between the emitter and the target;
adjusting the initial gain to a second gain based on the determined range distance; and
applying the second gain to the amplifier to subsequently amplify detected light pulses reflected from the target by the emitter.

14. The method of claim 13, further comprising comparing the determined range distance to a first range distance threshold, selecting the second gain to a first range of gains responsive to the determined range distance being less than the first range distance threshold, and selecting the second gain to a second range of gains responsive to the determined range distance being greater than the first range distance threshold.

15. The method of claim 14, wherein each of the first and second range of gains extends from a minimum to a maximum value along a selected linear slope, wherein a first gain mode has a first set of minimum, maximum and slope values, wherein a second gain mode has a different set of minimum, maximum and slope values.

16. The method of claim 13, wherein the amplifier is characterized as a transimpedance amplifier (TIA) that converts pulses obtained from a photodetector to voltage pulses, and wherein the gain adjustment circuit adjusts a gain applied to said voltage pulses.

17. The method of claim 13, wherein multiple pulses are emitted against the target and the distance to the target is determined responsive to a time of flight (ToF) responsive to a first elapsed time for a selected pulse from the multiple pulses to travel to the target, and a second elapsed time for a reflected pulse from the target associated with the selected pulse to travel from the target to a photodetector.

18. The method of claim 13, further comprising applying to the amplifier a first gain mode for a first target within a field of view (FoV) of the system at a first detected distance from the system and concurrently applying a different, second gain mode to the amplifier for a second target within the FoV at a second detected distance greater than the first detected distance.

19. The method of claim 13, wherein the gain adjustment circuit uses a Gilbert Cell arrangement comprising a plurality of transistors to adjust the gain of the amplifier.

20. The method claim 13, wherein the gain adjustment circuit uses a multiplier integrated circuit device and a differential amplifier to adjust the gain of the amplifier.
